(19) United States
(12) Patent Application Publication
(10) Pub. No.: US 2017/0257000 A1
(43) Pub. Date: Sep. 7, 2017

(54) ROTARY ELECTRICAL MACHINE STATOR PROVIDED WITH A COIL WITH AT LEAST ONE SHIELDED PHASE WINDING

(71) Applicant: VALEO EQUIPEMENTS ELECTRIQUES MOTEUR, Creteil Cedex (FR)

(72) Inventors: Geoffroy WILQUIN, Merck-Saint-Lievin (FR); Stéphane DE-CLERCQ, Rang du Fliers (FR); Vincent RAMET, Etaples (FR); Sébastien LECLERCQ, Humbert (FR)

(21) Appl. No.: 15/446,168

(22) Filed: Mar. 1, 2017

(30) Foreign Application Priority Data
Mar. 2, 2016 (FR) 1651783

(51) Int. Cl. H02K 3/12; H02K 3/28

(52) U.S. Cl. CPC H02K 3/12; H02K 3/28

(57) ABSTRACT

The invention relates mainly to a rotary electrical machine stator, in particular for a motor vehicle, comprising:
a stator body (11) with a central axis, the stator body (11) comprising a series of notches (15);
a winding wound in the notches (15) in the stator body (11) forming a first chignon (231) and a second chignon (232) extending axially on both sides of the stator body (11); wherein at least one of the phase windings (PH1-PH3, PH1′-PH3′) is a shielded winding which comprises all the active portions (20) of the layer (C1, CN) situated at one of the radial ends at least of each notch (15) of the series, each extended firstly by a corresponding connection portion (21) of the first chignon (231), and secondly by a corresponding connection portion (21) of the second chignon (232).

### CROSS-REFERENCE TO RELATED APPLICATIONS AND CLAIM TO PRIORITY

This application is related to Patent Application No. 1651783 filed Mar. 2, 2016 in France, the disclosure of which is incorporated herein by reference and to which priority is claimed.

### Field of the Invention

The present invention relates to a rotary electrical machine stator provided with a winding with at least one shielded phase winding.

The invention has a particularly advantageous application for a rotary electrical machine stator such as, for example, an alternator, an alternator-starter, or an electric motor.

### BACKGROUND OF THE INVENTION

In a known manner, rotary electrical machines comprise a stator and a rotor integral with a shaft. The rotor can be integral with a drive shaft and/or a driven shaft, and can belong to a rotary electrical machine in the form of an alternator or an electric motor.

The rotor comprises a body formed by a stack of sheets of plates which are kept in the form of a set by means of an appropriate securing system, such as rivets which pass through the rotor axially from one side to the other. The rotor comprises poles formed for example by permanent magnets accommodated in cavities provided in the magnetic mass of the rotor. Alternatively, in a so-called “projecting” poles architecture, the poles are formed by coils wound around arms of the rotor.

The stator comprises a body constituted by a stack of thin plates, as well as a phase winding received in notches in the stator which are open towards the interior. There are generally three or six phases. In the stators of alternators of this type, the most commonly used types of windings are firstly so-called “concentric” windings, constituted by coils wound around teeth of the stator, and secondly windings of the type known as “undulating”, which are described for example in document FR2483702.

The undulating winding comprises a plurality of phase windings each formed from at least one continuous electrical conductor. Each winding comprises a plurality of turns which pass through the notches in the stator body. Each winding comprises connection portions situated alternatively on each side of the stator, connecting to one another active portions which are situated inside notches in the stator. A series of connection portions which extends from a side of the stator constitutes a chignon of the winding.

Document FR2947968 teaches the implementation of a method for winding in situ in which the series of phase windings is wound at the same time and in parallel in the corresponding notches in the stator body. In the case of a hexaphase winding comprising two three-phase systems, this means that the inputs of the two systems are situated at an inner periphery of the stator because of their injection in the first winding turn. FIG. 1 thus illustrates the positioning of the inputs E1-E3 of a three-phase system obtained from active portions 2 forming in the notches 3 the layers which are closest to the axis of the stator 1. In addition, the outputs (not represented) of the two systems obtained at the end of the winding are grouped together at the outer periphery of the stator.

The problem is that, because of their end radial positioning, the inputs are liable to interfere with the rotor, whereas the outputs can potentially come into contact with the bearing of the electrical machine, and cause short-circuits. In order to prevent this, it is known to position the inputs and the outputs inside connection portions situated in the intermediate part of the winding chignons. However, these operations, which are carried out manually, are lengthy to perform, and therefore costly in terms of labour.

### SUMMARY OF THE INVENTION

The objective of the invention is to eliminate this disadvantage efficiently by proposing a rotary electrical machine stator, in particular for a motor vehicle, comprising:

a stator body with a central axis, the said stator body comprising a series of notches;

a winding wound in the said notches in the said stator body forming a first chignon and a second chignon extending axially on both sides of the said stator body;

the said winding comprising phase windings in which each phase winding is formed by at least one continuous electrical conductor passing into a series of notches in the assembly, the said phase winding comprising at least two turns;

each phase winding comprising:

active portions which are each positioned in a notch of the series of notches, the said active portions forming in each notch of the series successive radial layers;

connection portions, each connection portion forming a part of one of the chignons, each of the connection portions extending from the notches on a single side of the said stator body, from one of the active portions towards another active portion of a successive notch of the series of notches;

a first end and a second end extending from one of the active portions on the exterior of the notches;

characterised in that at least one of the phase windings is a shielded winding which comprises all the active portions of the layer situated at one of the radial ends at least of each notch of the series, each extended firstly by a corresponding connection portion of the first chignon, and secondly by a corresponding connection portion of the second chignon.

In other words, none of the layers situated at one and/or the other of the radial ends of the notches of the series comprises active portions which are extended in a first or a second phase end out of the notch.

The invention thus makes it possible to shield an active portion extended by a phase end, which prevents the phase inputs and/or outputs from being able to interfere with the rotor or come into contact with the bearing of the electrical machine. In addition, since a positioning of this type of the phase winding inputs and outputs can be carried out during the winding, there is elimination of the manual step of putting inputs and outputs into place in the chignons, which is costly to carry out.

According to one embodiment, the said winding comprises at least one system comprising at least three shielded windings.

According to one embodiment, the said winding comprises at least two systems each comprising three shielded windings.

According to one embodiment, the phase outputs of the first three-phase system are offset by 125° from the phase outputs of the second three-phase system.

According to one embodiment, the phase outputs of the first three-phase system are offset by 125° plus or minus N times 30° from the phase outputs of the second three-phase system.

According to one embodiment, each shielded winding comprises at least two continuous electrical conductors.

According to one embodiment, the at least one shielded winding comprises N layers in each notch, a first layer which is furthest away from the said central axis and an Nth layer which is closest to the said central axis, at least the two ends of the conductor of the phase winding each extending from a corresponding active portion situated between the first layer inclusive and the Nth-1 layer inclusive.

According to one embodiment, at least one shielded winding is arranged such that each notch comprises a close layer, known as the final layer or close layer, which is the layer closest to the central axis relative to the other layers, and all the active portions which are situated in a close layer are each extended firstly by a corresponding connection portion of the first chignon, and secondly by a corresponding connection portion of the second chignon.

According to one embodiment, at least one shielded winding is arranged such that each notch comprises a first layer, known as the first layer or distant layer, which is the layer furthest from the central axis relative to the other layers in a notch, the active portion situated in the distant layers each being extended firstly by a corresponding connection portion of the first chignon, and secondly by a corresponding connection portion of the second chignon.

According to one embodiment, each phase winding comprises a connection portion situated radially between two connection portions of two other phase windings.

According to one embodiment, the said winding is of the distributed undulating type. This makes it possible to improve the magnetic performance of the stator.

According to one embodiment, the said stator body is formed by a stack of plates.

According to one embodiment, the said notches have parallel edges.

According to an embodiment other than the preceding one, the said notches have trapezoidal edges.

According to one embodiment, the active portion of a phase which extends from the input Ei, known as the shielded active portion, is in a notch known as the shielded notch, the connection portion which extends from the shielded portion is known as the input connection portion, the first active portion extending from the input connection portion is in a first notch in which: the input connection portion is situated between the shielded active portion and the first active portion, the second active portion which extends from the first connection portion which extends from the first active portion is situated in a second notch, and the first notch is situated between the shielded notch and the second notch.

According to an example of this embodiment, the shielded notch is the Nth notch, N being the notch number of a phase.

According to an embodiment other than the one previously described, the active portion of a phase which extends from the input Ei, known as the shielded active portion, is in a notch known as the shielded notch, the connection portion extending from the shielded portion is known as the input connection portion, the first active portion extending from the input connection portion is in a first notch in which: the input connection portion is situated between the shielded active portion and the first active portion, the second active portion which extends from the first connection portion which extends from the first active portion is situated in a second notch, and the shielded active portion is situated in the second notch.

The invention also relates to a rotary electrical machine, characterised in that it comprises a stator as previously defined.

### BRIEF DESCRIPTION OF THE DRAWINGS

The invention will be better understood by reading the following description and examining the figures which accompany it. These figures are provided purely by way of illustration of the invention which is in no way limiting.

FIG. 1, already described, is a partial view in perspective illustrating the positioning of the inputs of the end inner side of a wound stator according to the prior art;

FIG. 2 is a partial view in perspective of the interior of a stator in which the conductors of a phase winding are arranged according to the invention;

FIG. 3 is a partial view in perspective illustrating the positioning of the inputs of a three-phase system for a wound stator according to the present invention;

FIG. 4 represents a view in linear cross-section of the stator, showing the positioning of the inputs of a three-phase system in the radial layers of conductors situated inside the notches in the stator;

FIG. 5 represents a view in linear cross-section of the stator, showing the positioning of the outputs of a three-phase system in the radial layers of conductors situated inside the notches in the stator;

FIGS. 6a to 6c represent schematically, according to a linear development of a spindle, the different winding steps which make it possible to shield an input of a phase winding;

FIGS. 7a to 7c represent, according to a linear development of a spindle, the different winding steps which make it possible to shield an output of a phase winding.

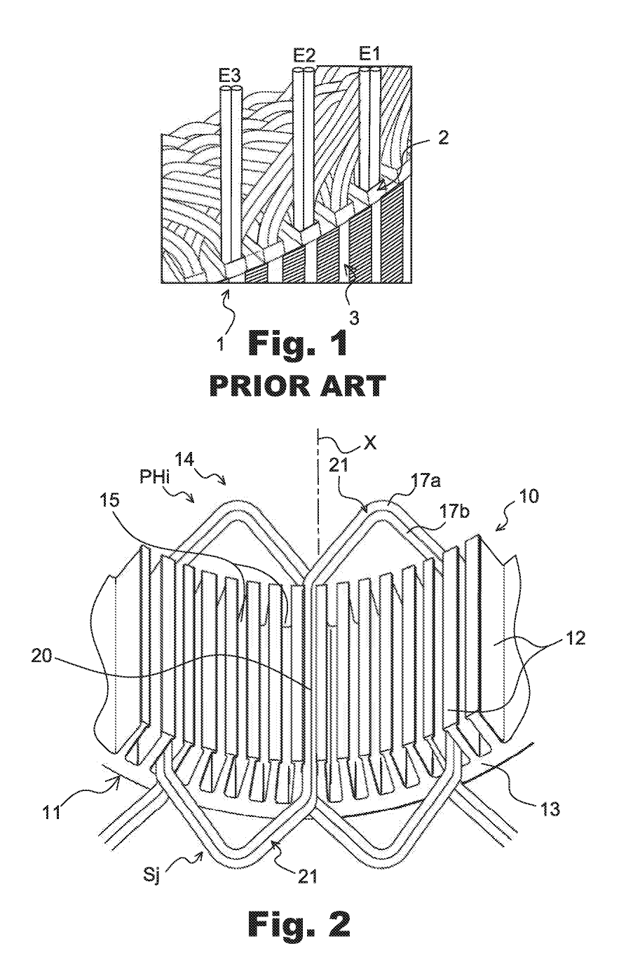

Elements which are identical, similar or analogous retain the same reference from one figure to another.

### DETAILED DESCRIPTION OF THE PREFERRED EMBODIMENT(S)

FIG. 2 is a partial view in perspective of a stator 10 of a rotary electrical machine which comprises mainly a body 11 in which there are fitted a plurality of phase windings PH1-PH3, PH1′-PH3′ forming a winding 14. In order to facilitate understanding, a single phase winding PHi is represented in FIG. 2. The rotary machine is for example an alternator or an alternator-starter. This machine is preferably designed to be implemented in a motor vehicle. It will be remembered that an alternator-starter is a rotary electrical machine which can work reversibly, firstly as an electric generator in alternator function, and secondly as an electric motor, in particular in order to start the thermal engine of the motor vehicle.

The stator body 11 has an annular cylindrical form with a central axis X, and consists of an axial stack of flat plates. The body 11 comprises teeth 12 which are distributed angularly regularly around an inner circumference of a head 13. These teeth 12 delimit in pairs notches 15. The head 13 corresponds to the solid annular portion of the body 11, which extends between the base of the notches 15 and the outer periphery of the body 11.

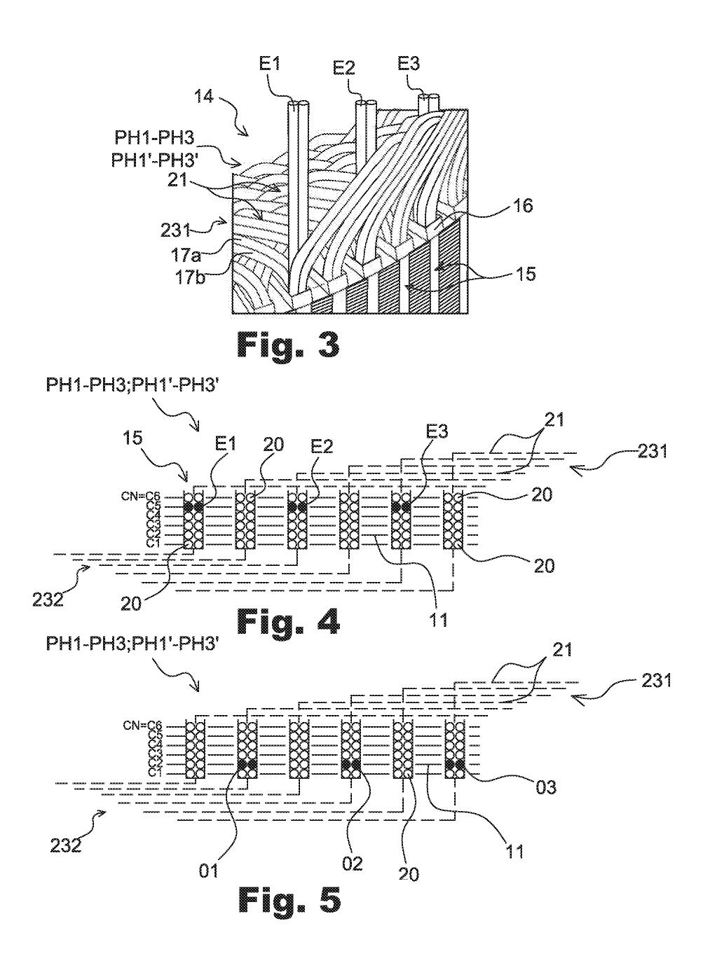

The notches 15 open axially on both sides of the body 11. The notches 15 are also open radially in the inner face of the body 11. The notches 15 preferably have parallel edges, i.e. the inner faces of the teeth 12 opposite one another are parallel to one another. There are for example 36, 48, 60, 72, 84 or 96 of the notches 15. In the embodiment, the stator 10 comprises 72 notches. As can be seen better in FIG. 3, insulators 16 are arranged in the notches 15 of the stator.

In order to form the winding 14 of the stator 10, a plurality of phase windings are installed in the notches 15 in the body 11. In this case the “hexaphase” stator 10 comprises six phase windings formed by two three-phase systems PH1-PH3, PH1′-PH3′ coupled to one another. The first PH1-PH3 and the second PH1′-PH3′ systems are preferably offset from one another by 125°.

The invention can however be applied to stators 10 comprising a different number of phase windings, for example to pentaphase windings (with five phase windings) or heptaphase windings (with seven phase windings).

Each phase winding PHi is constituted in this case by two continuous conductors 17a, 17b wound inside the stator 10 in the notches 15 in order to form a turn Sj. Each phase winding PHi is formed by a plurality of concentric turns Sj forming the winding 14 of the complete phase. Each phase winding PHi thus comprises at least two turns Sj.

As a variant, each phase winding PHi is formed by a single one, or more than two, conductors 17. In this case, the conductors 17a, 17b have a round cross-section. Alternatively, in order to optimise the filling of the notches 15, the conductors 17a, 17b can have a rectangular or square cross-section. The conductors 17a, 17b are preferably made of copper covered with enamel.

Each phase winding PHi is associated with a series of notches 15 of the set of notches, such that each notch 15 receives several times the conductors 17a, 17b of a single phase. Two consecutive notches 15 of a series are separated by adjacent notches, each corresponding to another series of notches 15 associated with one of the other phase windings PH1-PH3, PH1′-PH3′. Thus, when there are K phases, the conductors 17a, 17b of a single phase winding PHi are inserted every K notches 15.

Each phase winding PHi comprises active portions 20 each positioned in a notch 15 of the corresponding series of notches. As can be seen in FIGS. 4 and 5, the active portions 20 form in each notch 15 of the series N successive radial layers C1-CN. The first layer C1 is defined as being the layer furthest from the axis X, and the Nth layer is defined as being the layer radially closest to the axis X.

Each phase winding PHi also comprises connection portions 21 which are situated alternately on both sides of the stator 10, and connect to one another active portions 20 situated in a series of notches associated with a given phase winding PHi. Thus, each connection portion 21 forms part of a first chignon 231 or a second chignon 232. The two chignons 231, 232 extend axially on both sides of the stator 10. Each of the connection portions 21 extends out of the notch 15 on a single side of the stator body 11, from one of the active portions 20 to another active portion 20 of a successive notch 15 in the series of notches 15.

In addition, each phase winding PHi comprises a first end and a second end corresponding respectively to a phase input Ei and output Oi extending from one of the active portions 20, on the exterior of the notch 15. These ends Ei, Oi can be connected to terminals of the electrical machine.

As can be seen clearly in FIGS. 3 and 4, each winding PHi is arranged such that all the active portions 20 situated in the Nth layer CN of each notch 15 are each extended firstly by a corresponding connection portion 21 of the first chignon 231, and secondly by a corresponding connection portion 21 of the second chignon 232.

In addition, as can be seen clearly in FIG. 5, each winding PHi is arranged such that all the active portions 20 situated in the first layer C1 of each notch 15 are each extended firstly by a corresponding connection portion 21 of the first chignon 231, and secondly by a corresponding connection portion 21 of the second chignon 232.

Thus, the two ends of the conductors 17a, 17b of each phase winding PHi, in other words the input Ei and the output Oi, each extend from a corresponding active portion 20 situated between the second layer C2 inclusive and the N-1th layer inclusive. In other words, none of the radial end layers comprises active portions 20 which are extended by a first or a second phase end Ei, Oi out of the notch 15.

Alternatively, there are N layers, and the input Ei and output Oi of each phase winding PHi each extend from a corresponding active portion 20 situated between the first layer C1 inclusive and the N-1th layer CN inclusive, in the case when only the inputs Ei are shielded, in other words between the first layer C1 inclusive and the Nth layer not inclusive.

Alternatively there are N layers, and the input Ei and output Oi of each phase winding PHi each extend from a corresponding active portion 20 situated between the second layer C2 inclusive and the Nth layer CN inclusive, in the case when only the outputs Oi are shielded, in other words between the first layer C1 not inclusive and the Nth layer inclusive.

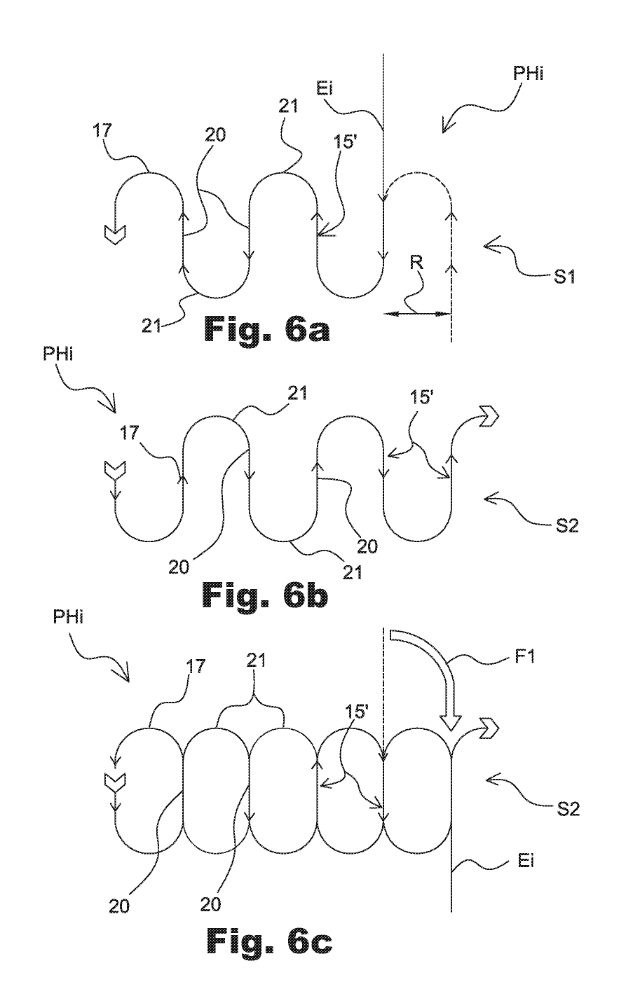

A description is provided hereinafter with reference to FIGS. 6a to 6c of the winding principle which makes it possible to shield the inputs of the phase windings PH1-PH3, PH1′-PH3′. In order to facilitate understanding, a single phase winding PHi is represented, but the steps can be generalised to all of the phase windings PH1-PH3, PH1′-PH3′. In addition, only a single conductor 17 is represented, although the winding 14 is preferably made of two wires in hand per phase (cf. conductors 17a, 17b).

The principle consists of reintroducing the phase inputs Ei into the winding only when at least the first interior turn S1 has been wound. More specifically, as can be seen in FIG. 6a, relative to the final positioning of the inputs, each phase winding PHi is started with a delay R for example of approximately 30° on the development of the winding, which corresponds to a half wave. The input end Ei is in this case kept on the exterior of the notches 15′ during the winding of the first turn 51, and at least part of the second turn S2 (cf. FIG. 6b). In each turn S1, S2 the active portions 20 are positioned in the interior of the notches 15′ of the series dedicated to the said phase winding PHi.

The active portions 20 are each in a notch 15′. The active portion 20 which extends from the input Ei, known as the shielded active portion, is in a notch 15′ known as the shielded notch 15′. The connection portion 21 which extends from the shielded portion is known as the input connection portion. The first active portion 20 which extends from the input connection portion 21 is in a first notch 15′. Consequently, the input connection portion 21 is situated between the shielded active portion and the first active portion 20. The second active portion 20 which extends from the first connection portion 21 which extends from the first active portion 15′ is situated in a second notch 15′, and so on N times. Each phase comprises its first notch, its second notch, etc.

Once the first turn S1 has been formed and at least one active portion is situated in the shielded notch of the second turn S2, the shielded active portion of the phase winding PHi corresponding to an input Ei is deposited in the notch 15′ corresponding to the final positioning, as represented by FIG. 6c (cf. arrow F1). In this embodiment, the first notch 15′ is situated between the shielded notch and the second notch. The shielded notch is then the notch N. Each phase winding end of the phase winding PHi corresponding to an input Ei is deposited in the notch 15′ corresponding to the final positioning. The phase inputs Ei are then between two connection positions with at least one turn S1 which retains them and therefore prevents them from being detached from the chignons 231, 232. Winding turns then continue to be formed until the required number of layers is obtained in each notch 15′.

According to another example not represented, once the turn S1 has been formed, each shielded active portion of each phase winding PHi corresponding to an input Ei is deposited in the second notch 15′ corresponding to the final positioning. Thus, the second notch 15′ is the shielded notch 15′, and the input connection portion is opposite the first connection portion.

The number of turns Sj wound before reintroduction of the phase input ends Ei can be variable. Thus, it will be possible to form one turn or more before reinsertion of the phase inputs Ei. The number of turns Sj wound before the insertion of the inputs Ei corresponds to the number of layers situated in the interior of the notches 15′ before the positioning of the input Ei. Consequently, the more turns Sj are wound before the insertion of the inputs Ei, the more the inputs Ei are distant from the inner periphery of the stator 10.

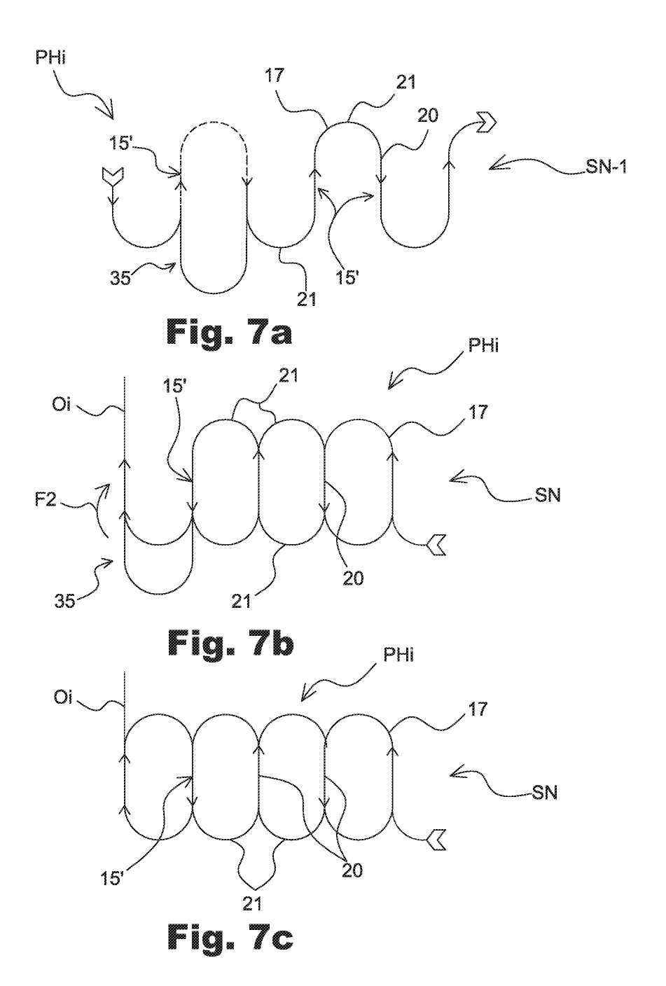

With reference to FIGS. 7a to 7c, a description is provided hereinafter of the winding steps which make it possible to shield the outputs Oi of each phase winding PHi. More specifically, as can be seen in FIG. 7a, a part 35 of the next to last turn SN-1 is wound outside the winding which exists at the notch 15′ designed to receive the output end Oi of the winding PHi during the winding of the final turn SN.

As represented in FIG. 7b, when the final turn SN is formed, the end which forms the output Oi is positioned on the exterior of the notch 15′, and the part of turn 35 is inserted in the notch according to the arrow F2, such as to cover the phase output Oi. The phase outputs Oi are then between two connection portions with a turn SN which retains them, and therefore prevents them from becoming detached from the chignons 231, 232 (cf. FIG. 7c).

The number of portions of turns 35 wound outside the tooling or the stator can be variable. Thus, it will be possible to wind outside the tooling or the stator two parts of turns 35 or more before folding them back on the corresponding output Oi. The number of parts of turns 35 wound outside the tooling or the stator corresponds to the number of layers situated in the interior of the notches after the positioning of the output Oi. Consequently, the more parts of turns 35 there are wound outside the spindle, the more the outputs Oi will be distant from the outer periphery of the stator 10 after covering.

It should also be noted that the winding 14 obtained is of the distributed undulating type. In fact, FIGS. 2, 6c and 7c show that, for two adjacent notches 15 of a series of notches 15′ associated with a phase winding PHi, the winding has two connection portions 21 situated on both sides of the stator 10 connecting active portions 20 of one of the notches 15 adjacent to those of the other. A winding of this type makes it possible to improve the magnetic performance of the electrical machine.

In addition, because of the simultaneous winding of the six phase windings PH1-PH3, PH1′-PH3′ comprising a plurality of turns, each winding PHi comprises at least one connection portion 21 which is situated radially between two connection portions 21 of two other windings.

By winding the six phase windings PH1-PH3, PH1′-PH3′ in the same manner, six shielded phase windings are obtained, i.e. six phase windings PH1-PH3, PH1′-PH3′ with inputs Ei and outputs Oi which are not positioned in the end layers of the notches 15, and are thus shielded by the other phase windings PH1-PH3, PH1′-PH3′ of the winding.

As a variant, it is possible to wind some of the phase windings PH1-PH3, PH1′-PH3′ as previously indicated, such that they have their phase input Ei and output Oi shielded. As a variant, only the inputs Ei or the outputs Oi of the phase windings PH1-PH3, PH1′-PH3′ are shielded. The selection of the number of phase windings PH1-PH3, PH1′-PH3′ with inputs Ei and/or outputs Oi which will be shielded depends on the application.

In this case, the winding 14 is produced on tooling before being transferred to the notches 15 of the stator 10. As a variant, the winding 14 can be produced flat on a stator before being curved to form an annular stator according to a so-called bending method.

Persons skilled in the art will be able to refer to document FR2947968 for further details on carrying out the winding method implemented in the invention.

It will be appreciated that the foregoing description has been provided purely by way of example, and does not limit the field of the invention, a departure from which would not be constituted by replacement of the details of execution by any other equivalents.

1. Rotary electrical machine stator (10), in particular for a motor vehicle, comprising:
a stator body (11) with a central axis (X), said stator body (11) comprising a series of notches (15);
a winding (14) wound in said notches (15) in said stator body (11) forming a first chignon (231) and a second chignon (232) extending axially on both sides of said stator body (11);
said winding (14) comprising phase windings (PH1-PH3, PH1′-PH3′) in which each phase winding (PH1-PH3, PH1′-PH3′) is formed by at least one continuous electrical conductor (17a, 17b) passing into a series of notches (15) in the assembly, said phase winding (PH1-PH3, PH1′-PH3′) comprising at least two turns (S1, S2);
each phase winding (PHi) comprising:
active portions (20) which are each positioned in a notch (15) of the series of notches, said active portions (20) forming in each notch (15) of the series successive radial layers (C1-CN);
connection portions (21), each connection portion (21) forming a part of one of the chignons (231, 232), each of the connection portions (21) extending from the notches (15) on a single side of said stator body (11), from one of the active portions (20) towards another active portion (20) of a successive notch (15) of the series of notches;
a first end (Ei) and a second end (Oi) extending from one of the active portions (20) on the exterior of the notches (15);
wherein at least one of the phase windings (PH1-PH3, PH1′-PH3′) is a shielded winding which comprises all the active portions (20) of the layer (C1, CN) situated at one of the radial ends at least of each notch (15) of the series, each extended firstly by a corresponding connection portion (21) of the first chignon (231), and secondly by a corresponding connection portion (21) of the second chignon (232).

2. Stator according to claim 1, wherein said winding (14) comprises at least one system (PH1-PH3) comprising at least three shielded windings.

3. Stator according to claim 1, wherein said winding (14) comprises at least two systems (PH1-PH3, PH1′-PH3′) each comprising three shielded windings.

4. Stator according to claim 3, wherein the phase outputs of the first three-phase system are offset by 125° from the phase outputs of the second three-phase system (PH1-PH3, PH1′-PH3′).

5. Stator according to claim 1, wherein each shielded winding (PHi) comprises at least two continuous electrical conductors (17a, 17b).

6. Stator according to claim 1, wherein at least one shielded winding (PHi) comprises N layers in each notch (15), a first layer (C1) which is furthest away from said central axis (X) and an Nth layer (CN) which is closest to said central axis (X), and wherein at least the two ends (Ei, Oi) of the conductor (17a, 17b) of the phase winding (PHi) each extend from a corresponding active portion (20) situated between the first layer (C1) inclusive and the Nth-1 layer (CN) inclusive.

7. Stator according to claim 1, wherein at least one shielded winding (PHi) is arranged such that each notch (15) comprises a close layer, known as the final layer or close layer, which is the layer (CN) closest to the central axis (X) relative to the other layers, and wherein all the active portions (20) which are situated in a close layer (CN) are each extended firstly by a corresponding connection portion (21) of the first chignon (231), and secondly by a corresponding connection portion (21) of the second chignon (232).

8. Stator according to claim 1, wherein at least one shielded winding (PHi) is arranged such that each notch (15) comprises a distant layer (C1), known as the first layer, which is the layer furthest from the central axis (X) relative to the other layers, and wherein the active portions (20) situated in the distant layers of the notches (15) are each extended firstly by a corresponding connection portion (21) of the first chignon (231), and secondly by a corresponding connection portion (21) of the second chignon (232). 15

9. Stator according to claim 1, wherein each phase winding (PH1-PH3, PH1′-PH3′) comprises a connection portion (21) situated radially between two connection portions (21) of two other phase windings.

10. Stator according to claim 1, wherein said winding (14) is of the distributed undulating type.

11. Stator according to claim 1, wherein said stator body (11) is formed by a stack of plates.

12. Stator according to claim 1, wherein said notches (15) have parallel edges.

13. Rotary electrical machine, comprising a stator (10) as defined according to claim 1.

14. Stator according to claim 2, wherein said winding (14) comprises at least two systems (PH1-PH3, PH1′-PH3′) each comprising three shielded windings.

15. Stator according to claim 2, wherein each shielded winding (PHi) comprises at least two continuous electrical conductors (17a, 17b).

16. Stator according to claim 3, wherein each shielded winding (PHi) comprises at least two continuous electrical conductors (17a, 17b).

17. Stator according to claim 4, wherein each shielded winding (PHi) comprises at least two continuous electrical conductors (17a, 17b).
